(19) United States
(12) Patent Application Publication
(10) Pub. No.: US 2013/0139963 A1
(43) Pub. Date: Jun. 6, 2013

(54) PHOTO-CURABLE RESIN COMPOSITION AND METHOD FOR PREPARING OF REPLICA MOLD USING THE SAME

(71) Applicant: Bong Kuk LEE, Daejeon (KR)

(72) Inventor: Bong Kuk LEE, Daejeon (KR)

(73) Assignee: Electronics and Telecommunications Research Institute, Daejeon (KR)

(21) Appl. No.: 13/617,261

(22) Filed: Sep. 14, 2012

(30) Foreign Application Priority Data
Dec. 2, 2011 (KR) 10-2011-0128462

(51) Int. Cl. C08G 77/20; B32B 37/12

(52) U.S. Cl. 156/329; 522/44

(57) ABSTRACT

The present invention relates to a photo-curable resin composition and a method for preparing a replica mold using the same. The photo-curable resin composition according to the present invention comprises a photo-reactive polymer comprising polydimethylsiloxane (PDMS) that binds to silsesquioxane comprising at least one polymeric functionalized group; and a photo-initiator.

### CROSS-REFERENCE TO RELATED APPLICATIONS

This application is based on and claims priority from Korean Patent Application No. 10-2011-0128462, filed on Dec. 2, 2011, with the Korean Intellectual Property Office, the present disclosure of which is incorporated herein in its entirety by reference.

### FIELD OF INVENTION

The present invention relates to a photo-curable resin composition for use in the preparation of a replica mold used to form a pattern on a substrate.

### BACKGROUND OF THE INVENTION

As a method for forming a pattern on a substrate, lithography techniques, such as photolithography and electronbeam lithography, have been used. Since these techniques are complicated and very expensive in forming a nanopattern, simple and economical techniques, such as softlithography and nanoimprint lithography, are drawing attention.

However, softlithography and nanoimprint lithography have a disadvantage that a mold prepared to form a pattern is distorted, which causes lowering the accuracy in the shaped pattern.

Meanwhile, a hard mold, such as silicon and quartz, has superior mechanical strength and thermal stability and is chemically inert, and thus can clearly form a pattern. However, the hard mold is not uniformly in contact with a substrate due to a lack of flexibility and gas permeability, which leads to porosity defects on the surface of the substrate.

On the other hand, a soft mold, such as an elastic PDMS, has low surface tension and superior flexibility and gas permeability. However, the soft mold causes unwanted contact with a substrate after polymerization with a monomer due to swelling and restricts a clear formation of a pattern on a substrate due to low Young's modulus.

Accordingly, there has been an increased requirement for a replica mold combining the advantages of a hard mold and a soft mold, and various replica molds comprising self-replicating materials to meet such need have been developed.

Self-replicating materials include silicon-containing hybrid materials, such as photo-curable organosilicon prepolymer, acrylate-modified polydimethylsiloxane (PDMS), SiO₂—TiO₂ sol-gel-based acrylics, poly(3-mercaptopropyl)-methylsiloxane/acrylic blends, silsesquioxane-based acrylics and GLYMO containing SiO₂—TiO₂ sol-gel, amorphous fluoropolymer, (meth)acrylated perfluoropolyether, polyurethane acrylate and fluorinated hybrid materials.

Herein, the hybrid materials are successfully used for the preparation of a replica mold. The related techniques are disclosed in KR 2011-0030740, JP 2010-013514 and JP 2009-073078. However, in order to prepare a replica mold using hybrid materials, it is required to reform the surface by using a mold releasing agent.

Meanwhile, the self-replicating materials, such as amorphous fluoropolymer, (meth)acrylated PFPE, polyurethane acrylate and fluorinated hybrid materials, can be used in preparing a replica mold without need to reform the surface by using a mold releasing agent, due to their low surface tension. However, these materials are unstable in forming a nanopattern of less than 40 nm having high density and aspect ratio due to their low elasticity (S. S. Williams et al., Nano Lett. 2010, 10, 1421)

### SUMMARY

It is an objective of the present invention to provide a photo-curable resin composition that concurrently meets various physical properties, such as low viscosity, low surface tension (high hydrophobicity or high water contact angle), high Young's modulus, adjustability of elasticity modulus in a broad range, low contraction, low swelling ratio, high transparency and high gas permeability, with a relatively simple preparation process and a short production time without requiring an additional processing using a mold releasing agent.

Further, it is the other objective of the present invention to provide a method for forming a replica mold using the aforementioned photo-curable resin composition.

In order to achieve the aforementioned objectives, the present invention provides a photo-curable resin composition, comprising a photo-reactive polymer comprising polydimethylsiloxane (PDMS) that binds to silsesquioxane having at least one polymeric functionalized group, and a photo-initiator.

The polymeric functionalized group can be selected from the group consisting of methacrylate, acrylate, glycidylether, oxetane, epoxycyclohexane and vinylether.

Further, the polydimethylsiloxane that binds to the silsesquioxane may have a weight average molecular weight of 1,000 to 4,000.

The photo-curable resin composition according to the present invention may further comprise a photo-reactive monomer.

Meanwhile, the present invention provides a method for preparing a replica mold comprising the steps of: applying the photo-curable resin composition on a first substrate, and disposing a second substrate on the first substrate, on which the photo-curable resin composition is applied, and then curing.

Further, the present invention provides a replica mold prepared according to the method for preparing the replica mold.

### EFFECT OF THE INVENTION

The present invention can conveniently prepare a replica mold without an additional processing using a mold releasing agent, because a replica mold is prepared by using a photo-curable resin composition comprising silsesquioxane to which PDMS having low surface tension binds.

Further, the present invention can provide a replica mold that exhibits high Young's modulus and elasticity and has superior flexibility and gas permeability, and can form a nanopattern having high resolution and accuracy, because a nanopattern is formed on a substrate using a replica mold having such properties.

### BRIEF DESCRIPTION OF THE DRAWINGS

FIGS. 1 to 6 illustrate nanopatterns formed in a replica mold.

FIG. 7 illustrates a replica mold prepared using a conventional photo-curable resin composition.

FIGS. 8 to 11 illustrate the physical properties of the photo-curable resin composition and the replica mold according to the present invention.

### DETAILED DESCRIPTION

Hereinafter, the present invention is described in detail.

1. Photo-curable Resin Composition

The photo-curable resin composition according to the present invention comprises a photo-reactive polymer having low surface tension and a photo-initiator.

The photo-reactive polymer contained in the photo-curable resin composition comprises a polydimethylsiloxane (PDMS) that binds to silsesquioxane having at least one polymeric functionalized group and lowers the surface tension of a composition.

That is, the photo-reactive polymer of the present invention comprises at least one polymeric functionalized group and polydimethylsiloxane that bind to silsesquioxane having Si—O—Si as a basic frame. Silsesquioxane is prepared by hydrolyzing trialkoxysilane and having it undergoing a sol-gel state in a solution. In order for the silsesquioxane to be used as a photo-reactive polymer in the present invention, it is preferable that trialkoxysilane and polydimethylsiloxane are present in the weight ratio of 6:4-9:1 when polydimethylsiloxane binds to silsesquioxane.

Although not particularly limited, the at least one polymeric functionalized group that the silsesquioxane has is preferably selected from the group consisting of methacrylate, acrylate, glycidylether, oxetane, epoxtcyclohexane and vinylether as long as it is a radical polymeric type or a anionic polymeric type.

Further, the structure of the silsesquioxane can be selected from the group consisting of a random structure, a complete box structure, a stepladder structure and an incomplete box structure.

Although the polydimethylsiloxane that binds to the silsesquioxane of the present invention is not particularly limited as long as it is well-known in the relevant art, in consideration of the surface tension, the polydimethylsiloxane is preferable to use one having the weight average molecular weight in the range between 1,000 and 4,000.

The polydimethylsiloxane that binds to the photo-reactive polymer of the present invention can be represented by chemical formula 1 below:

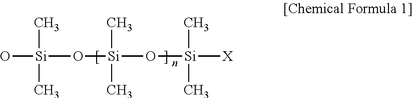

wherein X is H, OH, CH₃ or CH₂CH₃ and n is an integer from 11 to 52.

The photo-reactive polymer of the present invention may be formed by additionally binding another functionalized group together with polydimethylsiloxane to silsesquioxane having at least one polymeric functionalized group. Herein, although the functionalized groups that can be additionally bound not particularly limited, unlimited examples are alcohols, amines, carboxylic acids, fluoroalkyls, halides, imides, nitriles, norbornenyls, olefins, sulfonates or thiols.

The photo-reactive polymer of the present invention can be represented by structural formulae 1 to 6 below:

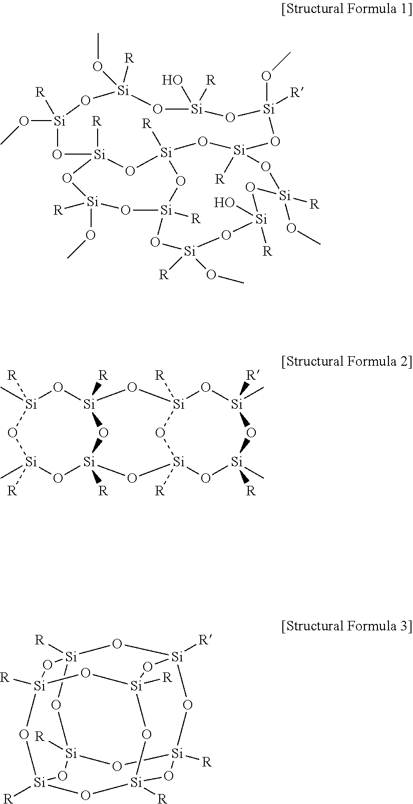

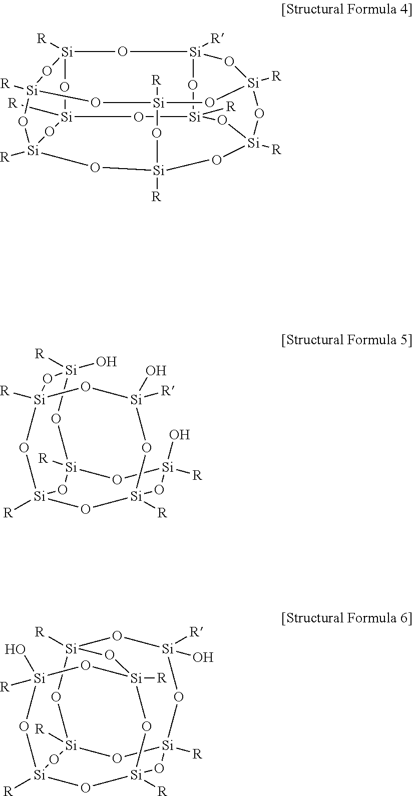

wherein R is a polymeric functionalized group as stated above and R′ is polydimethylsiloxane as stated above. Further, Structural Formula 1 has silsesquioxane of a random structure, Structural Formula 2 has silsesquioxane of a stepladder structure, Structural Formula 3 and 4 have silsesquioxane of a complete box structure and Structural Formulae 5 and 6 have silsesquioxane of an incomplete box structure

As set out above, the photo-reactive polymer of the present invention comprises polydimethylsiloxane having low surface tension that binds to silsesquioxane having high mechanical strength. Accordingly, when using a photo-curable resin composition comprising the photo-reactive polymer, a replica mold can be conveniently prepared without an additional processing using a mold releasing agent due to low surface tension, and can have a clear and accurate nanopattern due to high mechanical strength.

In particular, the photo-curable resin composition of the present invention has a water contact angle of 90° to 110°, which implies that the photo-curable resin composition of the present invention has low surface tension. The water contact angle is generally defined as an angle formed by the contact of water and a solid and is influenced by surface tension between water and a solid. That is, the larger the water contact angle, the lower the surface tension of a solid, and the smaller the water contact angle, the higher the surface tension of a solid. In accordance with this principle, the photo-curable resin composition of the present invention exhibits a relatively high water contact angle in the range between 90° and 110°, and thus has low surface tension.

Meanwhile, although not particularly defined, in consideration of the viscosity of the photo-curable resin composition and the physical property of the prepared replica mold, the amount of the photo-reactive polymer is preferably 1 to 99 wt % based on 100 wt % of the photo-curable resin composition.

The photo-initiator contained in the photo-curable resin composition of the present invention initiates polymerization by absorbing light energy (specifically, ultraviolet light). Although not particularly limited, materials available as the photo-initiator are preferably at least one selected from the group consisting of 2,2′-dimethoxy-2-phenylacetophenone, 2-hydroxy-2-methyl-1-phenyl-propane-1-one, 2,4,6-trimethylbenzoyl-diphenylphosphine oxide and diphenyl 2,4,6-trimethylbenzoyl phosphine oxide.

Although not particularly limited, in consideration of curability of the photo-curable resin composition, the amount of the photo-initiator is preferably 1 to 5 wt % based on 100% of the photo-curable resin composition.

Meanwhile, the photo-curable resin composition of the present invention may further comprise a photo-reactive monomer having rapid polymerization. Herein, although not particularly limited, materials available as a photo-reactive monomer are preferably acrylic-based compounds having an acrylate or a methacrylate. Such acrylic-based compounds can be selected from the group consisting of mono-functionalized monomers, di-functionalized monomers, tri-functionalized monomers, multi-functionalized monomers and/or polymers, and a mixture of at least one therefrom.

Unlimited examples of the mono-functionalized monomers available as the acrylic-based compounds are methyl acrylate, methyl methacrylate, ethyl acrylate, ethyl methacrylate, butyl acrylate, butyl methacrylate, tert-butyl acrylate, tert-butyl methacrylate, isobutyl acrylate, isobutyl methacrylate, hexyl acrylate, hexyl methacrylate, octyl acrylate, octyl methacrylate, nonyl acrylate, nonyl methacrylate, decyl acrylate, decyl methacrylate, isodecyl acrylate, isodecyl methacrylate, lauryl acrylate, lauryl methacrylate, allyl acrylate, allyl methacrylate, benzyl acrylate, benzyl methacrylate, cyclohexyl acrylate, cyclohexyl methacrylate, phenyl acrylate, phenyl methacrylate, vinyl acrylate, vinyl methacrylate, glycidyl acrylate, glycidyl methacrylate, isobornyl acrylate, isobornyl methacrylate, urethane monoacrylates, (meth)acrylate mono-functionalized silsesquioxanes and silicone mono-(meth)acrylates.

Unlimited examples of the di-functionalized monomers available as the acrylic-based compounds are ethylene glycol diacrylate, ethylene glycol dimethacrylate, diethylene glycol diacrylate, diethylene glycol dimethacrylate, triethylene glycol diacrylate, triethylene glycol dimethacrylate, poly(ethylene glycol) diacrylate, poly(ethylene glycol) dimethacrylate, dipropylene glycol diacrylate, dipropylene glycol dimethacrylate, tripropylene glycol diacrylate, tripropylene glycol dimethacrylate, polypropylene glycol diacrylate, polypropylene glycol dimethacrylate, ethoxylated bisphenol A diacrylate, ethoxylated bisphenol A dimethacrylate, neopentyl glycol diacrylate, neopentyl glycol dimethacrylate, propoxylated neopentyl glycol diacrylate, propoxylated neopentyl glycol dimethacrylate, 1,12-dodecanediol diacrylate, 1,12-dodecanediol dimethacrylate, 1,3-butylene glycol diacrylate, 1,3-butylene glycol dimethacrylate, 1,4-butanediol diacrylate, 1,4-butanediol dimethacrylate, 1,6-hexanediol diacrylate, 1,6-hexanediol dimethacrylate, alkoxylated aliphatic diacrylate, alkoxylated cyclohexane dimethanol diacrylate, alkoxylated hexanediol diacrylate, alkoxylated neopentyl glycol diacrylate, cyclohexane dimethanol diacrylate, alkoxylated cyclohexane dimethanol diacrylates, urethane di(meth)acrylates, (meth)acrylate di-functionalized silsesquioxanes and silicone di-(meth)acrylates.

Unlimited examples of the tri-functionalized monomers available as the acrylic-based compounds are trimethylolpropane triacrylate, ethoxylated trimethylolpropane triacrylate, propoxylated trimethylolpropane triacrylate, propoxylated glycerol triacrylate, pentaerythritol triacrylate, tris(2-hydroxyethyl)isocyanurate triacrylate, urethane triacrylates, (meth)acrylate tri-functionalized silsesquioxanes and silicone tri-(meth)acrylates.

Unlimited examples of the multi-functionalized monomers available as the acrylic-based compounds are di(trimethylolpropane) tetraacrylate, dipentaerythritol pentaacrylate, ethoxylated pentaerythritol tetraacrylate, pentaacrylate ester, pentaerythritol tetraacrylate, urethane triacrylates, (meth)acrylate multi-functionalized silsesquioxanes and silicone tri-(meth)acrylates.

When the photo-curable resin composition of the present invention further comprises a photo-reactive monomers, although not particularly defined, in consideration of the viscosity of the photo-curable resin composition and the physical property of the prepared replica mold, the amount of the photo-reactive monomer is preferably in the range between 1 and 98 wt % based on 100 wt % of the photo-curable resin composition.

Meanwhile, the photo-curable resin composition of the present invention is prepared by mixing the photo-reactive polymer, the photo-initiator and the photo-reactive monomer, and can be additionally mixed with an additive that is commonly used within the range that does not affect the physical property of the photo-curable resin composition.

As such, the viscosity of the photo-curable resin composition of the present invention is 0.1 to 3.000 cp, particularly 0.5 to 2.100 cp. Further, the photo-curable resin composition of the present invention cured by light may exhibit the swelling ratio of 1.5% or less with respect to the organic solvent, Young's modulus in the range of 20 MPa to 4.5 GPa, contraction rate of 1 to 10%, and transparency of 90% or greater with respect to the ultraviolet wavelength of 365 nm.

2. Replica Mold and Method for Preparing the Same

The replica mold of the present invention is used to form a nanopattern on a substrate, and is prepared using the above-stated photo-curable resin composition. A description thereof is provided below.

First, a first substrate is prepared and a photo-curable resin composition is applied on the prepared first substrate. Here, a method for applying the photo-curable resin composition is not particularly limited as long as it is well-known in the relevant art. Next, a second substrate is disposed on the first substrate on which the photo-curable resin composition is applied (specifically, a second substrate is disposed on the applied photo-curable resin composition), and the photo-curable resin composition is cured using light. Thereafter, the first substrate and the second substrate are separated to prepare a replica mold.

Herein, when a replica mold is prepared by using a UV-assisted replica molding process, the first substrate corresponds to the master mold on which a nanopattern is formed, and the second substrate corresponds to the replica mold to which a photo-curable resin composition binds. On the other hand, when a replica mold is prepared by a UV-nanoimprint lithography, the second substrate corresponds to the master mold on which a nanopattern is formed, and the first substrate corresponds to the replica mold to which the photo-curable resin composition binds. In addition, a replica mold can be prepared by a roll-to-roll imprint. Further, second, third and fourth replica molds can be prepared in large quantities by repeating the above process or by using the prepared replica mold as a first replica mold.

Meanwhile, although not particularly limited, materials available as the first substrate and the second substrate are preferably quartz, glass, nickel, silicon, silicon oxide and transparent films, such as polyethyleneterephtalate (PET), polycarbonate (PC), poly vinyl chloride (PVC), and polydimethylsiloxane (PDMS), which have high ultraviolet transmission rate in order to enhance curability of the applied photo-curable resin composition. Further, such materials can be primer-treated in order to give adhesive property.

As set out above, the present invention can provide a replica mold having high Young's modulus and elasticity and superior flexibility and gas permeability, because a replica mold is prepared using a photo-curable resin composition having low contraction rate, high Young's modulus and superior permeability.

The present invention is described in more detail based on the examples and comparative examples below, but is not limited to the examples and comparative examples.

### Examples 1 to 7

### Preparation of Photo-Curable Resin Composition

A resin composition was prepared by mixing each ingredient in the mixture ratio shown in Table 1 below.

TABLE 1

| Component | | Example 1 | Example 2 | Example 3 | Example 4 | Example 5 | Example 6 | Example 7 |
|---|---|---|---|---|---|---|---|---|
| Photo-reactive polymer¹⁾ | | 96 | 1 | 1 | 48 | 48 | 20 | 20 |
| Photo-initiator²⁾ | | 4 | 4 | 4 | 4 | 4 | 4 | 4 |
| Photo- | Diethylene | — | 95 | — | 48 | — | 76 | — |
| reactive | Glycol | | | | | | | |
| monomer | Diacrylate | | | | | | | |
| | Ethylene | — | — | 95 | — | 48 | — | 76 |
| | Glycol | | | | | | | |
| | Dimethacrylate | | | | | | | |

| | | | | | | | |
|---|---|---|---|---|---|---|---|
| Total (wt %) | 100 | 100 | 100 | 100 | 100 | 100 | 100 |

¹⁾Toagosei Co., Ltd.: AC-SQ SI-20
²⁾Sigma-Aldrich: DMPA

### Comparative Example

A resin composition was prepared by mixing 48 wt % of Ebecryl 265 (75 wt % of urethane triacrylate+25 wt % of tripropylene glycol diacrylate), 48 wt % of epoxylated trimethylolpropane triacrylate, 1 wt % of Tegd Rad 2200N (silicon acrylate) and 3 wt % of a photo-initiator (1.5 wt % of Irgacure 184+1.5 wt % of Darocur 1173).

### Preparation Example 1

### Preparation of Replica Mold (Using a UV-Assisted Replica Molding Process

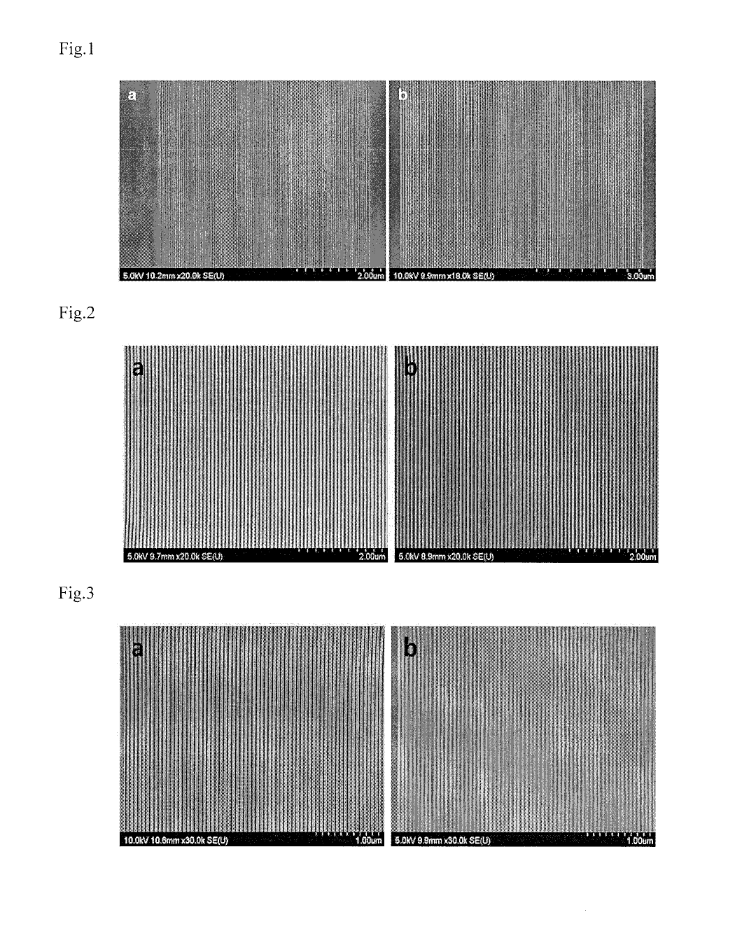

The resin composition prepared in Example 1 was dropped away on a PFOS (trichloro (1H, 1H, 2H, 2Hperfluorooctyl)silane; Sigma Aldrich)-modified silicon master mold (NTT-AT Corporation) to be dispensed. Thereafter, TMSPM (trimethoxyilylpropyl methacrylate)-modified quartz was disposed on the master mold on which the resin composition is applied, and was irradiated by ultraviolet light having a wavelength of 365 nm under vacuum state at room temperature for three hours using a mercury lamp of 80 W (INNO-CURE 100N; Lichtzen Co., Ltd.). The photo-curable resin composition, wherein a pattern is replicated in quartz, was separated from the master mold to prepare a first replica mold (A). As a result of observing the prepared first replica mold (A) using an electron microscope, it could be confirmed that a first replica mold (A), in which a clear and accurate nanopattern (25 nm) is formed, was prepared (see a in FIG. 1).

A second replica mold (B) was prepared by repeating the above process using the prepared first replica mold (A) instead of the master mold. As a result of observing the prepared second replica mold (B) using an electron microscope, it could be confirmed that a second replica mold (B), in which a clear and accurate nanopattern (25 nm) is formed, was prepared (see b in FIG. 1).

### Preparation Example 2

A first replica mold (C) was prepared in the same process as in Preparation Example 1 except for the use of the resin composition in Example 2 instead of the composition in Example 1. As a result of observing the prepared first replica mold (C), it could be confirmed that a first replica mold (C), in which a clear and accurate nanopattern (45 nm) is formed, was prepared (see a in FIG. 2).

Further, a second replica mold (D) was prepared using the prepared first replica mold (C) as the master mold as well as in Preparation Example 1. As a result of observing the prepared second replica mold (D) using an electron microscope, it could be confirmed that a second replica mold (D), in which a clear and accurate nanopattern (45 nm) is formed, was prepared (see b in FIG. 2).

### Preparation Example 3

A first replica mold (E) was prepared in the same process as in Preparation Example 1 except for the use of the resin composition in Example 4 instead of the composition in Example 1. As a result of observing the prepared first replica mold (E) using an electron microscope, it could be confirmed that a first replica mold (E), in which a clear and accurate nanopattern (32 nm) is formed, was prepared (see a in FIG. 3).

Further, a second replica mold (F) was prepared by using the prepared first replica mold (E) as the master mold as well as in Preparation Example 1. As a result of observing the prepared second replica mold (F) using an electron microscope, it could be confirmed that a second replica mold (F), in which a clear and accurate nanopattern (32 nm) is formed, was prepared (see b in FIG. 3).

### Preparation Example 4

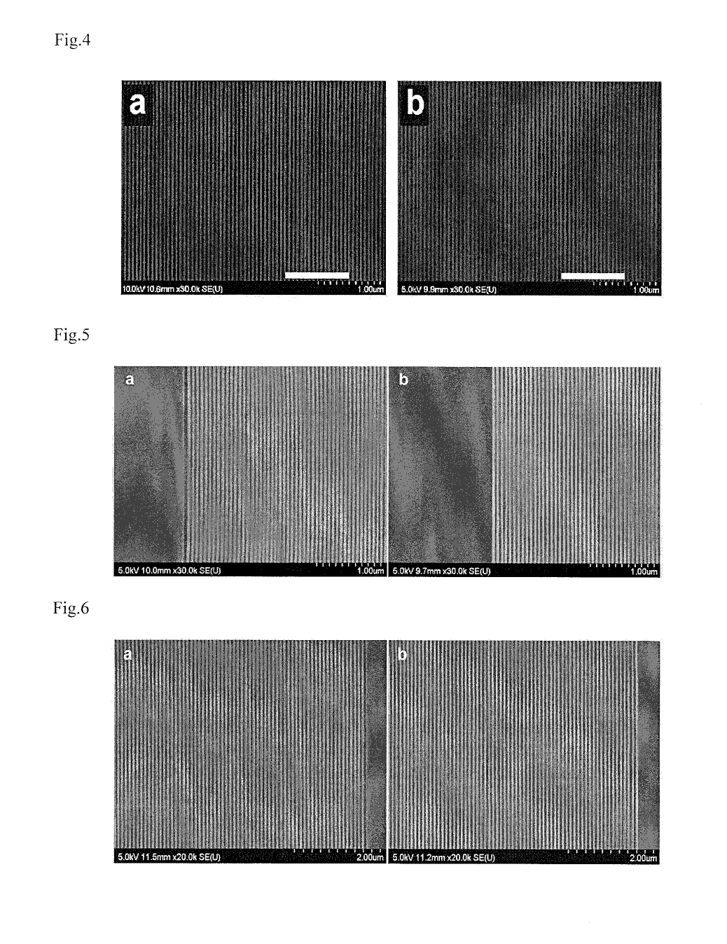

A first replica mold (G) was prepared in the same process as in Preparation Example 1 except for the use of the resin composition in Example 5 instead of the composition in Example 1. As a result of observing the prepared first replica mold (G) using an electron microscope, it could be confirmed that a first replica mold (G), in which a clear and accurate nanopattern (32 nm) is formed, was prepared (see a in FIG. 4).

Further, a second replica mold (H) was prepared by using the prepared first replica mold (G) as the master mold as well as in Preparation Example 1. As a result of observing the prepared second replica mold (H) using an electron microscope, it could be confirmed that a second replica mold (H), in which a clear and accurate nanopattern (32 nm) is formed, was prepared (see b in FIG. 4).

### Preparation Example 5

A first replica mold (I) was prepared in the same process as in Preparation Example 1 except for the use of the resin composition in Example 6 instead of the composition in Example 1. As a result of observing the prepared first replica mold (I) using an electron microscope, it could be confirmed that a first replica mold (I), in which a clear and accurate nanopattern (32 nm) is formed, was prepared (see a in FIG. 5).

Further, a second replica mold (J) was prepared by using the prepared first replica mold (I) as the master mold as well as in Preparation Example 1. As a result of observing the prepared second replica mold (J) using an electron microscope, it could be confirmed that a second replica mold (J), in which a clear and accurate nanopattern (32 nm) is formed, was prepared (see b in FIG. 5).

### Preparation Example 6

A first replica mold (K) was prepared in the same process as in Preparation Example 1 except for the use of the resin composition in Example 7 instead of the composition in Example 1. As a result of observing the prepared first replica mold (K) using an electron microscope, it could be confirmed that a first replica mold (K), in which a clear and accurate nanopattern (45 nm) is formed, was prepared (see a in FIG. 6).

Further, a second replica mold (L) was prepared by using the prepared first replica mold (K) as the master mold as well as in Preparation Example 1. As a result of observing the prepared second replica mold (L) using an electron microscope, it could be confirmed that a second replica mold (L), in which a clear and accurate nanopattern (45 nm) is formed, was prepared (see b in FIG. 6).

### Comparative Preparation Example

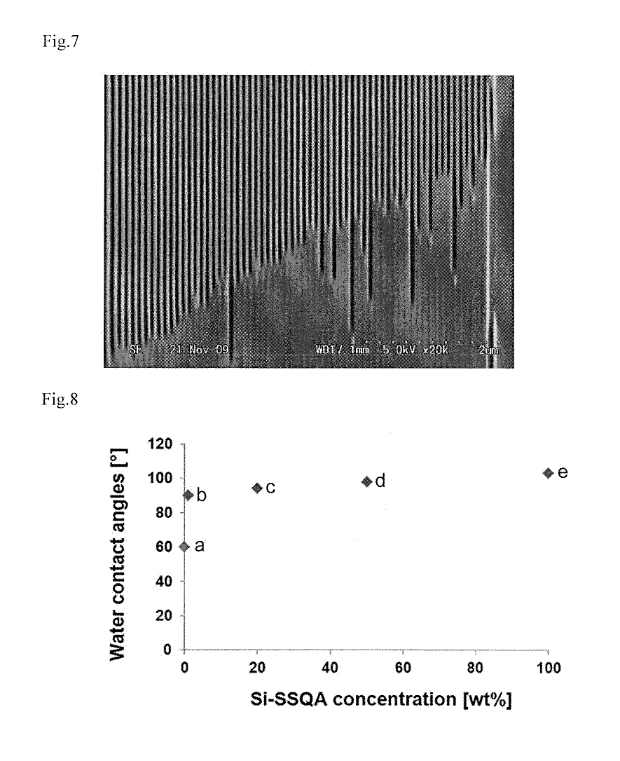

A first replica mold and a second replica mold were prepared in the same process as in Preparation Example 1 except for the use of the resin composition in the above Comparative Example instead of the composition in Example 1. As a result of observing the prepared second replica mold using an electron microscope, it could be confirmed that a second replica mold, in which a fault nanopattern (45 nm) is formed, was prepared (see FIG. 7).

As shown above, it could be confirmed that a replica mold, in which a nanopattern having high density and aspect ratio, can be prepared in large quantities using the photo-curable resin composition according to the present invention.

Meanwhile, the physical properties of the photo-curable resin composition according to the present invention and the replica mold prepared using the same were evaluated below.

1. Measurement of Viscosity of the Photo-curable Resin Composition

The viscosity of the photo-curable resin composition prepared in Examples 1 to 7 was measured at 25° C. by using a Brookfield viscometer, and the results are shown in Table 2 below.

TABLE 2

| | Exam- | Exam- | Exam- | Exam- | Exam- | Exam- | Exam- |
|---|---|---|---|---|---|---|---|
| | ple 1 | ple 2 | ple 3 | ple 4 | ple 5 | ple 6 | ple 7 |
| Vis- | 2100 | 12 | 4 | 62 | 25 | 19 | 6 |
| cosity | | | | | | | |
| (cp) | | | | | | | |

2. Measurement of Water Contact Angle of the Photo-curable Resin Composition

The resin compositions in Examples 1, 3, 5 and 7 were cured in the form of a film using a mercury lamp. Further, in Example 3, a resin composition was prepared by mixing 4 wt % of a photo-initiator and 96 wt % of a photo-reactive monomer without using a photo-reactive polymer, and then was cured in the form of a film. After allowing water drop away in the cured five films, the contact angle was measured using the well-known process in the relevant art. FIG. 8 revealed the results.

With reference to FIG. 8 (Example 1: e, Example 3: b, Example 5: d, Example 7: c and Example without including a photo-reactive polymer: a), it could be confirmed that the higher the content of the photo-reactive polymer, the greater the contact angle. This result supports that as the resin composition of the present invention comprises a photo-reactive polymer, it can have low surface tension.

3. Measurement of Permeability

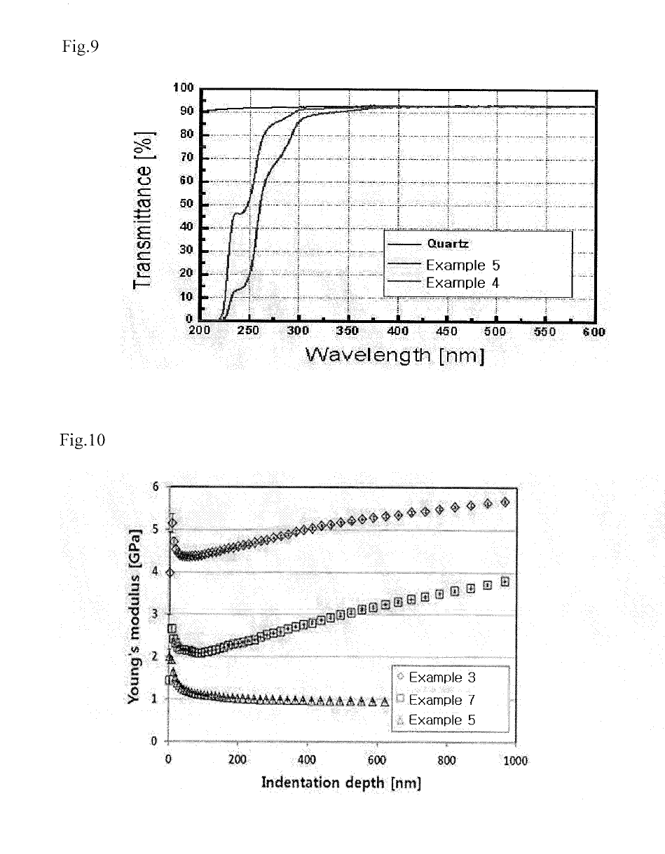

After curing the resin composition prepared in Examples 4 and 5 using a mercury lamp, UV-Vis transmission spectra was measured. The results are shown in FIG. 9 below. With reference to FIG. 9, it could be confirmed that the resin composition of the present invention exhibited high ultraviolet transmission of 90% or greater in the wavelength of 365 nm. This implies that the resin composition of the present invention is usefully available as a transparent mold for the preparation of a replica mold.

4. Measurement of Young's Modulus

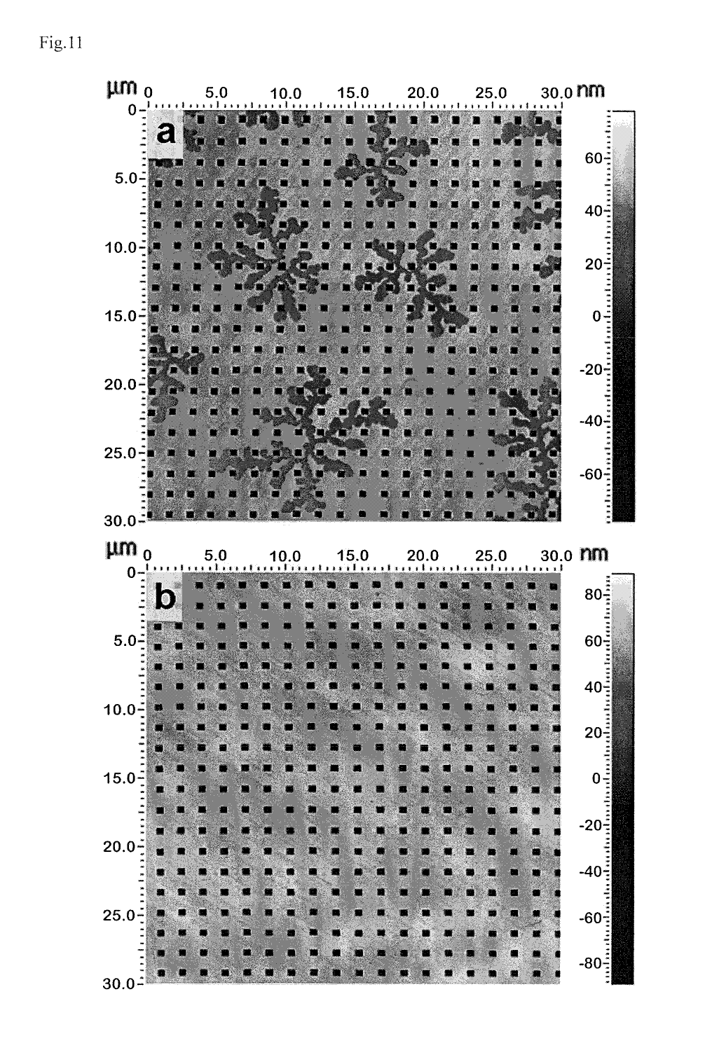

After curing the resin composition prepared in Examples 3, 5 and 7 by using a mercury lamp, Young's modulus was measured using nanoindentation. The results are shown in FIG. 10 below. Herein, Young's modulus having the contact depth between 30 nm and 200 nm was determined as a minimum Young's modulus.

With reference to FIG. 10, each minimum Young's modulus was measured as 4.45 GPa, 1.03 GPa and 2.11 GPa. These results are supported by the fact that Young's modulus can be adjusted from about 20 MPa to 4.45 GPa by adjusting the components contained in the resin composition of the present invention and their contents.

5. Measurement of Swelling Ratio

After the resin composition prepared in Examples 4 to 7 was cured by using a mercury lamp, it was soaked in an organic solvent for 48 hours to swell up. The results of measuring the swelling ratio (Qr) are shown in Table 3 below.

Swelling Ratio (Qr)=100%×(Wₛ−W_{d})/W_{d}

(Wₛ: Weight of the resin composition swelled in each organic solvent for 48 hours

W_{d}: Weight of the resin composition dried in a vacuum desiccate for 48 hours)

TABLE 3

| Organic Solvent | Example 4 | Example 5 | Example 6 | Example 7 |
|---|---|---|---|---|
| Ethanol | <0.8 ± 0.4 | <0.2 ± 0.2 | <1.0 ± 0.4 | <0.5 ± 0.3 |
| Toluene | <0.8 ± 0.4 | <0.2 ± 0.2 | <0.9 ± 0.4 | <0.4 ± 0.3 |
| Methylmethacrylate | <0.8 ± 0.3 | <0.1 ± 0.3 | <1.2 ± 0.5 | <0.4 ± 0.3 |

With reference to Table 3, it could be confirmed that the resin composition of the present invention exhibits significantly low swelling ratio of 1.2% or less in an organic solvent. This result supports that a replica mold prepared using the resin composition of the present invention can secure dimensional stability.

6. Measurement of Gas Permeability

After UV-NIL imprinting in a vacuum state using a second replica mold (L) prepared in Preparation Example 6 and a quartz master mold (NIM-100D: NTT-AT), a pattern was measured using AFM (Atomic Force Microscope). The results are shown in FIG. 11 (a: using a quartz mater mold/b: using a second replica mold (L)).

With reference to a in FIG. 11, it could be confirmed that a significant porosity defect having a diameter of 10 μm and a height of 30 nm occurred on the surface of the PEGDA pattern. However, it could be confirmed that no porosity defect occurred when using the second replica mold (L) in Preparation Example 6 (see b in FIG. 11). Such results support that the replica mold prepared using the resin composition of the present invention has superior gas permeability.

1. A photo-curable resin composition comprising:
a photo-reactive polymer comprising polydimethylsiloxane (PDMS) that binds to silsequioxane having at least one polymeric functionalized group;
and a photo-initiator.

2. The photo-curable resin composition as claimed in claim 1, wherein the polymeric functionalized group is selected from the group consisting of methacrylate, acrylate, glycidylether, oxetane, epoxycyclorohexane and vinylether.

3. The photo-curable resin composition as claimed in claim 1, wherein the polydimethylsiloxane that binds to the silsesquioxane has a weight average molecular weight of 1,000 to 4,000.

4. The photo-curable resin composition as claimed in claim 1, wherein the polydimethylsiloxane that binds to the silsesquixoane is represented by chemical formula 1 below: 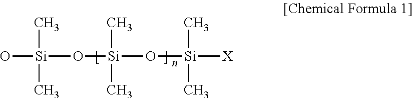
wherein X is H, OH, CH₃ or CH₂CH₃ and n is an integer from 11 to 52.

5. The photo-curable resin composition as claimed in claim 1, wherein the photo-reactive polymer is selected from one of structural formulae 1 to 6 below: 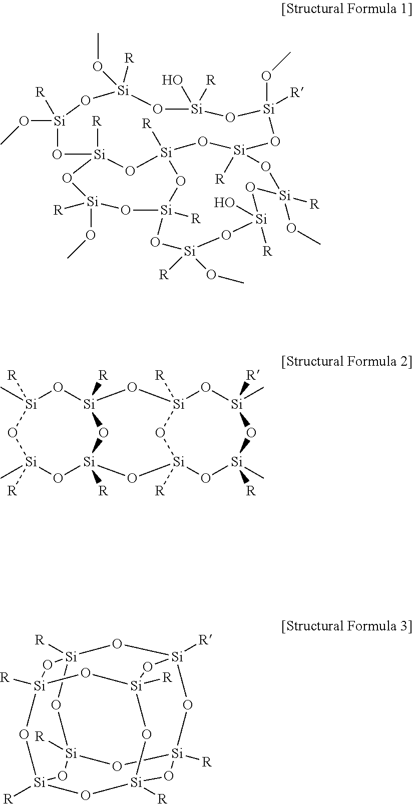 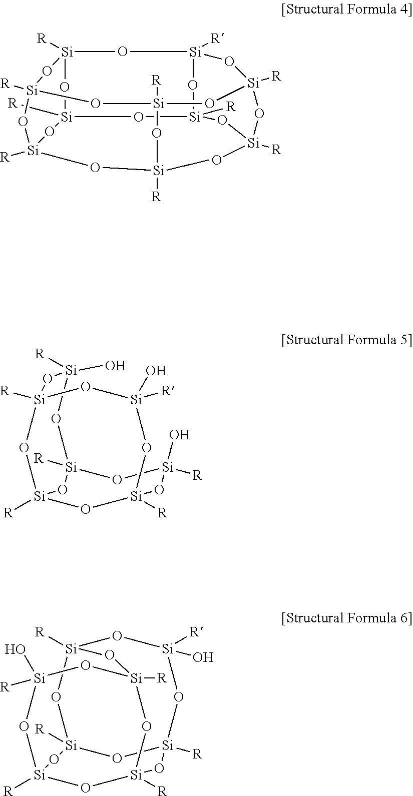
wherein R is the polymeric functionalized group and R′ is the polydimethylsiloxane.

6. The photo-curable resin composition as claimed in claim 1, wherein the photo-initiator is at least one selected from the group consisting of 2,2′-dimethoxy-2-phenylacetophenone, 2-hydroxy-2-methyl-1-phenyl-propane-1-one, 2,4,6-trimethylbenzoyl-diphenylphosphine oxide and diphenyl 2,4,6-trimethylbenzoyl phosphine oxide.

7. The photo-curable resin composition as claimed in claim 1, comprising 1 to 99 wt % of the photo-reactive polymer; and 1 to 5 wt % of the photo-initiator based on 100 wt % of the photo-curable resin composition.

8. The photo-curable resin composition as claimed in claim 1, further comprising a photo-reactive monomer.

9. The photo-curable resin composition as claimed in claim 1, a water contact angle is 90° to 110°.

10. A method for preparing a replica mold comprising the steps of:
applying the photo-curable resin composition according to claim 1 on a first substrate;
disposing a second substrate on the first substrate on which the photo-curable resin composition is applied; and then curing.

11. The method for preparing a replica mold as claimed in claim 10, wherein the polymeric functionalized group is selected from the group consisting of methacrylate, acrylate, glycidylether, oxetane, epoxycyclorohexane and vinylether.

12. The method for preparing a replica mold as claimed in claim 10, wherein the polydimethylsiloxane that binds to the silsesquioxane has a weight average molecular weight of 1,000 to 4,000.

13. The method for preparing a replica mold as claimed in claim 10, wherein the polydimethylsiloxane that binds to the silsesquixoane is represented by chemical formula 1 below: 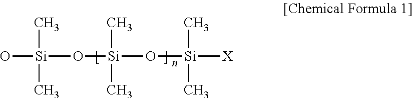
wherein X is H, OH, CH₃ or CH₂CH₃ and n is an integer from 11 to 52.

14. The method for preparing a replica mold as claimed in claim 10, wherein the photo-reactive polymer is selected from one of structural formulae 1 to 6 below: 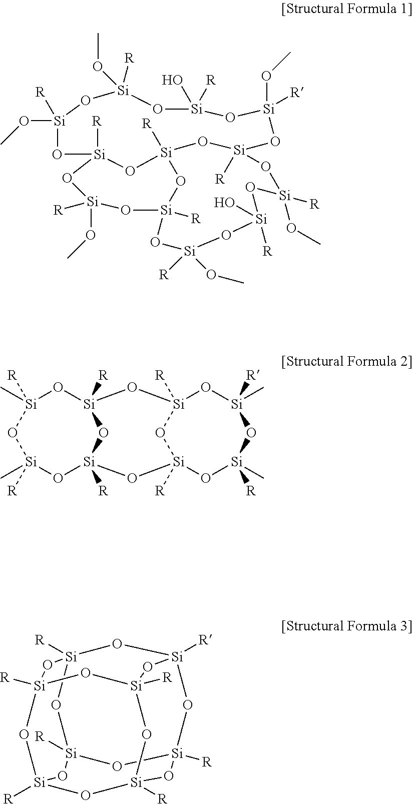 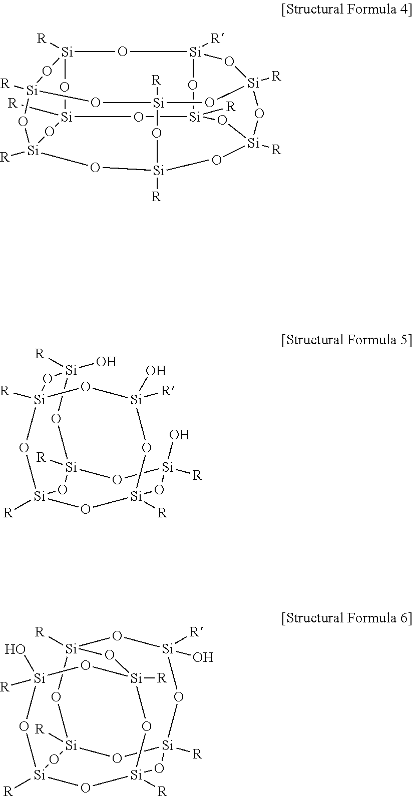
wherein R is the polymeric functionalized group and R′ is the polydimethylsiloxane.

15. The method for preparing a replica mold as claimed in claim 10, wherein the photo-initiator is at least one selected from the group consisting of 2,2′-dimethoxy-2-phenylacetophenone, 2-hydroxy-2-methyl-1-phenyl-propane-1-one, 2,4,6-trimethylbenzoyl-diphenylphosphine oxide and diphenyl 2,4,6-trimethylbenzoyl phosphine oxide.

16. The method for preparing a replica mold as claimed in claim 10, wherein the photo-curable resin composition comprises 1 to 99 wt % of the photo-reactive polymer; and 1 to 5 wt % of the photo-initiator based on 100 wt % of the photo-curable resin composition.

17. The method for preparing a replica mold as claimed in claim 10, wherein the photo-curable resin composition further comprises a photo-reactive monomer.

18. The method for preparing a replica mold as claimed in claim 10, wherein a water contact angle of the photo-curable resin composition is 90° to 110°.
